(19) United States
(12) Patent Application Publication
(10) Pub. No.: US 2002/0180603 A1
(43) Pub. Date: Dec. 5, 2002

(54) Package for tracking and monitoring devices

(76) Inventor: Michael A. Lyle, Gainesville, GA (US)

Correspondence Address: KENNEDY, DAVIS & HODGE, LLP, 5 CONCOURSE PARKWAY, SUITE 900, ATLANTA, GA, 30328, US

(21) Appl. No.: 09/776,411

(22) Filed: Feb. 2, 2001

(51) Int. Cl. G08B 13/14

(52) U.S. Cl. 340/572.9; 340/572.1

(57) ABSTRACT

A vessel that defines a cavity that receives a signaling or tracking and monitoring device, such as an EAS tag, RFID device, or the like, which vessel includes a piercing tip projecting from a first end of the vessel, whereby the piercing tip, bearing against a container, pierces an opening in the container for sliding passage of the vessel and the signaling device as a package into the container. A method of disposing signaling devices in containers is disclosed.

### TECHNICAL FIELD

The present invention relates to tracking and monitoring devices used with containers for goods. More particularly, the present invention relates to packages that hold tracking and monitoring devices for inserting into containers of goods for monitoring and tracking the containers.

### BACKGROUND OF THE INVENTION

Inventory tracking and monitoring of goods and containers of goods has taken on increased importance in recent years. There are a number of factors which have contributed to the need to accurately track and monitor inventory. Among these factors are just-in-time manufacturing in which materials are provided by suppliers shortly prior to the time of use by the manufacturer of goods, as well as theft deterrence and inventory verification and auditing.

Electronic and mechanical devices have been provided for tracking and monitoring of goods and containers. These devices include various tags, pods, labels, and patches which attach to or are inserted into containers to facilitate tracking and monitoring of goods and containers. For theft deterrence particularly, devices known as electronic article surveillance (“EAS”) tags are used in conjunction with articles and containers. EAS tags are small devices that are associated with the articles to be monitored. Typically, the articles for which EAS security monitoring is gainfully employed are these particularly susceptible to pilferage and improper removal from a warehouse or retail store. The EAS tags are typically inserted into packaging by an original manufacturer of the articles or attached to the packaging for the articles or the articles. EAS tags include a detectable sensor device. One known type of EAS tag has a circuit that resonates at a predetermined detection frequency range. A transmitter provides electromagnetic energy that excites the circuit. A receiver detects the output signal from the resonating circuit. The transmitter and the receiver are located at detection points, often exits from retail facilities. As the article is carried through the detection point, the receiver signals an alert when an activated sensor device is detected. For articles that are permitted to pass (such as purchased articles), a separate device is used to deactivate the detectable sensor prior to passage. Other devices include RFID devices that communicate digital signals. In some known RFID devices, the signal is indicative of unique identifiers for tracking particular containers.

Often large retailers require manufacturers of articles to include tracking and monitoring devices within the containers for the articles. For smaller retailers and smaller inventories of articles, the tracking and monitoring devices may not be included with or attached to containers. In such circumstances, the articles may be provided with after-market tracking and monitoring devices. For example, electronic article surveillance tags are available with adhesive backing to secure the tags to the containers. While the containers are thereby subject to electronic article surveillance, the adhesively attached tags experience problems during use. One significant problem is that the tags, being on the exterior of the container, are susceptible to removal. Removing the EAS tag facilitates unauthorized removal of the article from the secured area.

After-market application of monitoring and tracking devices however is limited by the containers for the articles to be protected. The containers provide secure and safe enclosures for protecting the articles from damage during shipping and handling, such as at warehouses and at retail stores, and also provide surfaces for labels including the brand name of the product, the manufacturer, usage instructions and inventory control information. The containers are made from a variety of materials, including corrugated paperboard, paperboard, cardboard, and plastic.

The tracking and monitoring devices are insertable into containers that are readily opened. However, many containers are further sealed by the supplier with shrink-wrap plastic sheeting or with adhesive seals that secure the top flaps. It is not practical for retailers to open such containers to insert tracking and monitoring devices, such as EAS tags. For after-market tracking and monitoring of goods and containers, the retailer is limited to using the devices that adhesively attach to the containers.

Accordingly there is a need in the art for providing a vessel that houses a tracking and monitoring device as a package that readily inserts into containers for providing electronic and mechanical tracking, monitoring, and surveillance of containers. It is to such that the present invention is directed.

### BRIEF SUMMARY OF THE INVENTION

The present invention meets the need in the art by providing a vessel that houses a tracking and monitoring device as a package for being disposed within a container of goods, comprising a vessel that defines a cavity and a piercing tip projecting from a first end of the vessel. A tracking and monitoring device is secured within the cavity. The piercing tip, bearing against a container, pierces an opening in the container for sliding passage of the vessel into the container.

In another aspect, the present invention meets the need in the art by providing a method of providing containers with a signaling package, comprising the steps of: (a) securing a signaling device within a cavity of a vessel having a piercing tip projecting from a first end; (b) opening a hole in a container by pushing the piecing tip into the container; and (c) sliding the remaining portion of the vessel through the hole into the container.

Objects, advantages and features of the present invention will become apparent from a reading of the following detailed description of the invention and claims in view of the appended drawings.

### BRIEF DESCRIPTION OF THE DRAWINGS

FIG. 1 is a perspective view of an embodiment of a vessel for holding a tracking and monitoring device according to the present invention.

FIG. 2 is a front perspective partial view of the vessel illustrated in FIG. 1.

FIG. 3 is a side view of the vessel illustrated in FIG. 1.

FIG. 4 is a side view of an alternate embodiment of the vessel illustrated in FIG. 1.

FIG. 5 is a perspective cut-away view of a container being pierced by the vessel illustrated in FIG. 1 for placing the tracking and monitoring device in the container.

FIG. 6 is a perspective view of a tool for assisting the insertion of the vessel of the present invention into a container, together with an alternate embodiment of the vessel illustrated in FIG. 1.

FIG. 7 is a perspective view of an alternate embodiment of the vessel of the present invention for holding a tracking and monitoring device.

FIG. 8 is a perspective exploded view of an alternate embodiment of the vessel of the present invention adapted for holding a tracking and monitoring device in adverse environments.

FIG. 9 is a perspective view of an alternate embodiment of the vessel according to the present invention for holding a tracking and monitoring device.

### DETAILED DESCRIPTION OF THE PREFERRED EMBODIMENTS

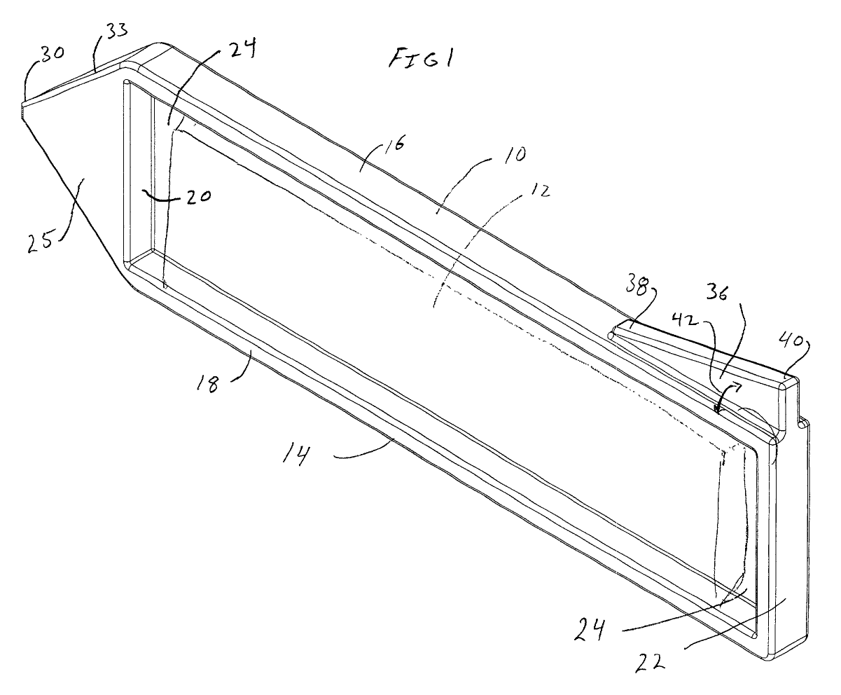

Referring now in more detail to the drawings in which like parts have like identifiers, FIG. 1 illustrates in perspective view an embodiment of a vessel 10 for holding a tracking and monitoring device 12 according to the present invention, for disposing within a container. The tracking and monitoring device 12 is a signaling device, such as an electronic or mechanical device that provides a response to an interrogation signal whereby an article associated with the device 12 may be monitored, tracked, or otherwise located. These devices include conventional electronic or mechanical tags, patches, labels, pods, and the like, conventional provided as EAS, RFID, or other tracking and monitoring devices.

The vessel 10 comprises an elongate body 14 with opposing side walls 16, 18, a front wall 20, and a back wall 22. These walls 16, 18, 20, and 22 cooperatively define a recessed cavity 24 within the vessel 10. The recessed cavity 24 is sized for receiving the tracking and monitoring device 12, such as a conventional electronic article surveillance (EAS) tag. Such EAS tag conventionally comprises a outer, box-like closed housing in which is disposed a magneto-mechanical element and a magnetic biasing element. These cooperate to generate a detectable signal, such as in the manner disclosed in U.S. Pat. No. 4,510,489. In that EAS tags, their manufacture, and their use are conventional, no further discussion is made thereof. Similarly, the tracking and monitoring device 12 may be a conventional RFID device.

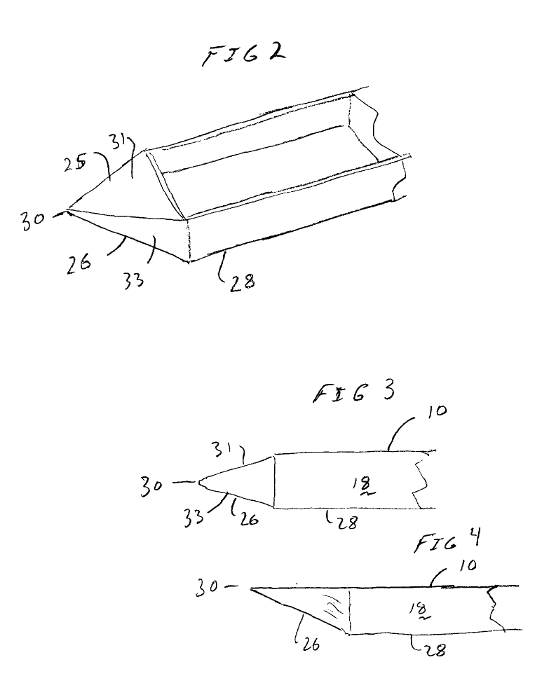

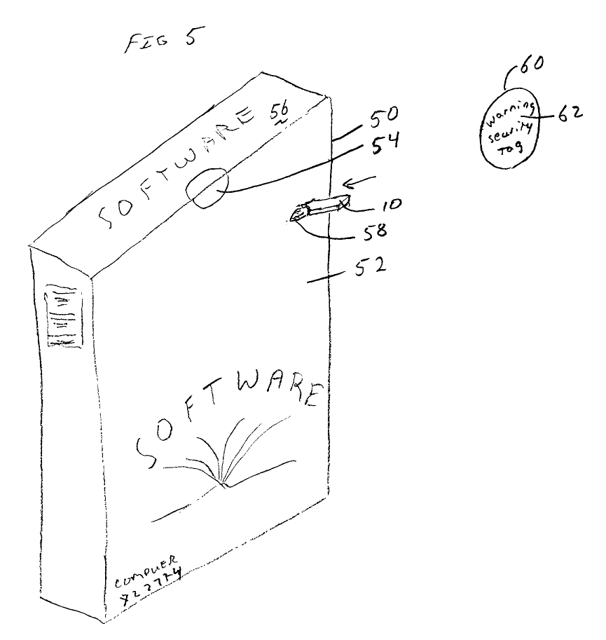

FIG. 2 is a front perspective partial view of the vessel 10 illustrated in FIG. 1. The vessel 10 includes a piercing tip 25 that projects from the front wall 20. In the illustrated embodiment, the piercing tip 25 defines a sharp edge 26 that extends at an oblique angle from a bottom surface 28 of the vessel 10 to the distal tip 30. With reference to FIGS. 3 and 4, the piercing tip 25 defines a substantially narrow and tapering semi-pyramidal projection from the vessel 10. FIG. 3 is a side view of the vessel illustrated in FIG. 1. In the embodiment illustrated in FIG. 3, opposing surfaces 31, 33 taper towards each other at oblique angles relative to a longitudinal axis of the vessel 10, to define the piercing tip 25. FIG. 4 is a side view of an alternate embodiment of the vessel 10 illustrated in FIG. 1. In this embodiment, the opposing surface 33 tapers to the distal tip 30, and thereby defines the sharp edge 26 of the piercing tip 25. The piercing tip 25 of the vessel 10 thereby defines a pointed bow with opposing angled surfaces 32 extending from the edge 26 to an upper side 34 of the vessel 10. The sharp edge 26 thereby tapers from the bottom surface 28 to the tip 30. The vessel 10 is readily manufactured by injection molding process of a plastic material.

With continuing reference to FIG. 1, a flange 36 extends outwardly from the side wall 16. The flange 36 defines an angular fin tapering from a narrow end 38 to a wide end 40 at the back wall 22. The flange 36 is preferably disposed at an oblique angle 42 relative to a plane defined by a longitudinal axis of the vessel 10.

In an alternate embodiment 10a of the vessel 10 illustrated in FIG. 7, a flange 46 extends outwardly from the back wall 22. In the illustrated embodiment, the flange 46 is substantially centrally disposed relative to the side edges of the back wall 22. In an alternate embodiment (not illustrated), the vessel 10 does not include either the flanges 36 or 46.

FIG. 5 is a perspective partially cut-away view of a container 50 being pierced through a front wall 52 by the vessel 10 for placing the tracking and monitoring device 12 in the container. The container 50 includes an adhesive patch 54 that seals a lid 56 and the front wall 52, commonly found on containers for software as well as other articles. The tip 25 of the vessel 10 pierces the wall 52 to define an opening 58 (shown by cut-away view of the vessel 10). The edge 26 of the vessel 10 cuts through the material of the container 50 to form the opening 58 for the vessel 10 to enter the container through the wall 52.

Exploded away from the container 50 is a sheet 60 having an adhesive surface on a first side and a printed notice on a second opposing side 62. The sheet 60 is a patch sized for being received on the container 50 over the opening 58, to close the opening, to prevent the opening from becoming larger, and to seal plastic wrapping from tearing or becoming ragged around the opening. The warning printed on the side 62 alerts persons to the placement of the tracking and monitoring device, which further serves as a deterrent to improper removal or theft of the container 50.

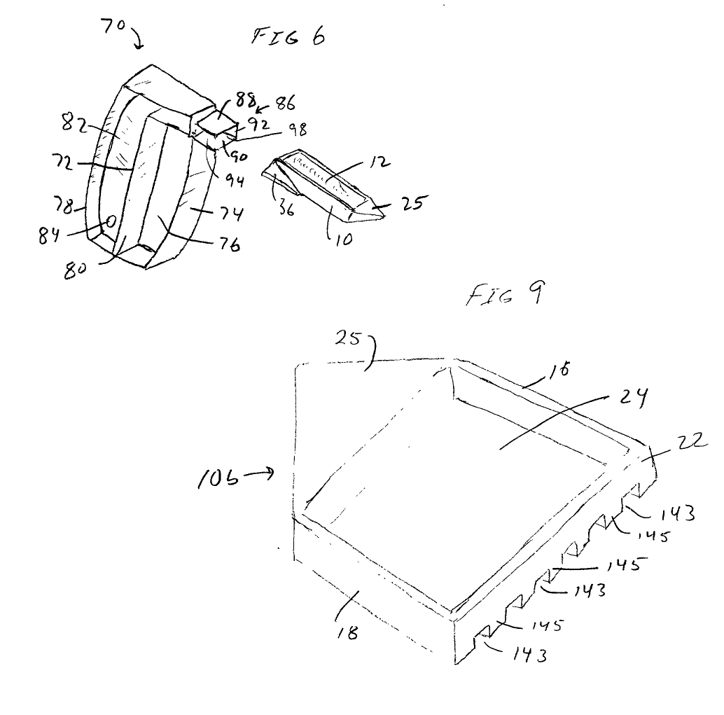

FIG. 6 is a perspective view of a tool 70 for assisting the insertion of the vessel 10 through a wall of a container in the practice of the present invention. The tool 70 is a molded body having a hand grip 72 and a front member 74 that cooperatively define an opening 76 for receiving the fingers of a hand of a person using the tool 70. The hand grip 72 is defined by walls 78, 80 with a web 82 recessed relative to side edges of the walls 78, 80. The web 82 defines an opening 84 for receiving a clip or other securing device, whereby the tool 70 can be attached to a tether or cord (not illustrated) for being carried on a belt of the person using the tool. The tool 70 is readily molded of plastic or other rigid material. The tip 86 may be made of metal and attached to the upper end of the tool 70.

A tip 86 extends outwardly at an upper portion of the tool 70. The tip 86 comprises a pair of parallel members 88, 90 joined together on a first side 92, and defining an open slot 94 on a side opposing the side 92. The members 88, 90 thereby define a recess 98 for receiving a rear portion of the vessel 10. The flange 36 of the vessel 10 slidingly passes along the slot 94 as the vessel 10 is received within the recess 98. The members 88, 90 grip the vessel 10 to hold it in the tool 70.

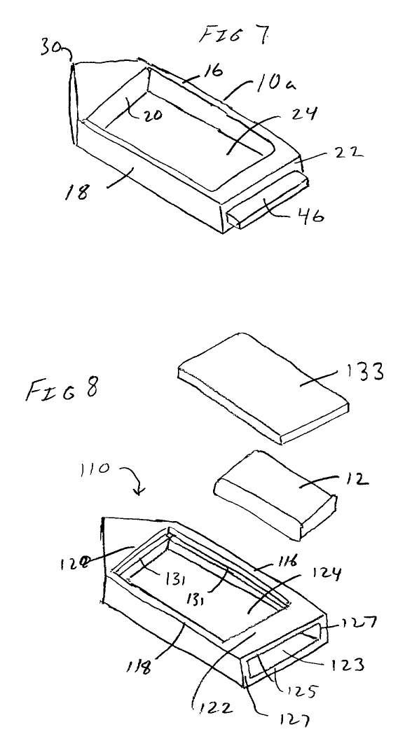

FIG. 8 is a perspective exploded view of an alternate embodiment of a vessel 110 of the present invention adapted for holding the tracking and monitoring device 12 in adverse environments. In this embodiment, the back wall 122 defines a recess 123 by the opposing top and bottom walls 125 and opposing side walls 127. As discussed below, the recess 123 cooperatively receives a tongue that extends from an alternate embodiment of the hand tool 70 for holding the vessel 110 while the container 50 is pierced for insertion of the vessel. In this alternate embodiment of the hand tool 70, the tip comprises an elongate member that slidingly engages the recess 123, during use of the tool for placing the vessel 110 in the container 50, as discussed below.

The vessel 110 further defines a lip 131 around the perimeter of the recess 124. The lip 131 is recessed from the distal edges surface of the walls 116, 118, 120, and 122. A lid 133 is illustrated exploded from the vessel 110. The lid 133 is sized for being received in the recess 124 and seating on the lip 131. The lid 133 closes the vessel 110. The lid 133 is secured by sonic or heat welding, by adhesive, or other securing mechanism, whereby the tracking and monitoring device 12 is housed within the vessel.

FIG. 9 is a perspective view of an alternate embodiment 10b of the vessel 10 according to the present invention for holding the tracking and monitoring device 12. In this embodiment, the back wall 22 defines a plurality of slots 143 and teeth 145. The recess 24 is substantially rectangular for receiving an alternate embodiment of the tracking and monitoring device 12.

With reference to FIGS. 1-5, the vessel 10 of the present invention provides a rigid carrier for depositing the tracking and monitoring device 12 within a container, such as the container 50 illustrated in FIG. 5. Some tracking and monitoring devices 12, such as known EAS tags, are susceptible to damage by bending, so the vessel 10 carries and protects the tracking and monitoring device 12 during insertion of the vessel and tracking and monitoring device into the container in after-market use. The tracking and monitoring device 12 is inserted into the recess 24. For example, EAS tags are available from various manufacturers, including Sensormatic Electronics Corporation, Boca Raton, Fla. Preferably, an adhesive layer, either applied to the recess 24 or on the tracking and monitoring device 12, secures the tracking and monitoring device in the recess. The recess 24 of the vessel 10 may then be filled with a resinous material, although this is not necessary in the practice of the invention.

The vessel 10 with the tracking and monitoring device 12 is then inserted into a closed container. The tip 30 is brought into contact with the wall 52, and the vessel 10 is pushed into the container 50 by bearing forcibly against the back wall 22. The sharp edge 26, together with the small tip 30, pierces the wall 52. The opening 58 is formed as the tapering walls of the piercing tip 25 penetrate the wall 52. The vessel 10 is thereby deposited within the container as the trailing portion of the vessel rearward of the piercing tip 25 follows the tip past the wall and into the container 50.

The vessel 10 pierces the opening 58 through the side wall 52 for passage of the vessel carrying the tracking and monitoring device 12 into the container 50. This leaves the exposed slit or opening 58 in the side wall of the container 50. Further, for containers that have plastic wrapping, the plastic may tear away or become ragged. The adhesive patch 60 is then applied to cover over the opening 58 and to secure the plastic wrap (if used) from tearing. The adhesive patch 60 preferably includes a notice that the container is subject to electronic article surveillance. This provides an additional benefit of discouraging persons from attempting to steal or improperly remove the container.

The insertion of the vessel 10 and the tracking and monitoring device 12 as a package into the container 50 is readily accomplished by hand. However, this process is facilitated by using the tool 70 illustrated in FIG. 6. The vessel 10 is slidingly engaged by the tip 86, with the flange 36 extending from the slot 94. The tool 70 is gripped using the hand grip 72 and moved to bear the piercing tip 26 forcibly against the wall 52 of the container 50.

Upon insertion of the vessel 10 into the container, the hand tool 70 is moved in an opposite direction. The flange 36 catches on the edges of the opening 58. The openings 58 in corrugated paperboard, cardboard, and paperboard tend to close together with frayed sides of fibers. These fibers and the closing sides of the opening 58 snag or catch on the flange 36. This enables the tool 70 to be extracted and detached from the vessel 10, while leaving the vessel and the tracking and monitoring device as a package within the container. In a preferred embodiment, the flange 36, disposed at an oblique angle, facilitates the extraction as the side edges of the opening 58 tend to close together even as the vessel 10 is inserted into the container and the tool is retracted. Similarly, the slots 143 and teeth 145 of the vessel 10b shown in FIG. 9 likewise catch on the side of the opening 58 for retaining the vessel 10b within the container as the insertion tool 70 is retracted.

The vessel 110 illustrated in FIG. 8 is particularly suited for use in environments adverse to the tracking and monitoring device 12. The vessel 110 is sealingly closed with the lid 133 that seats on the lip 131. The lid 133 is secured with adhesive, sonic welding, heat welding, or other securing mechanism.

It is to be appreciated that the package of the present invention provides the slim vessel 10 with the recessed cavity 24 that holds the tracking and monitoring device 12 for passage through the opening in the container, which opening is formed by the piercing tip 25 bearing against the container, in order to deposit the tracking and monitoring device 12 within the container for tracking, monitoring, and deterring theft of the container. The vessels disclosed herein are likewise usable with RFID (radio frequency identification) devices. These devices provide an electronic bar code or identifier for the container. The solid state RFID device, in the presence of a transmitter, become operational, and transmit the electronic bar code to a local receiver, for inventory tracking and monitoring, as well as for security from pilferage or theft from secured areas such as warehouse and retail facilities.

It is thus seen that a package for receiving an electronic article surveillance tag for being deposited within a container is provided by the present invention, whereby retailers may provide electronic or mechnical tracking and monitoring of goods and containers with the present invention of an aftermarket package of the vessel that holds the tracking and monitoring device for insertion into containers. While this invention has been described in detail with particular reference to the preferred embodiments thereof, the principles and modes of operation of the present invention have been described in the foregoing specification. The invention is not to be construed as limited to the particular forms disclosed because these are regarded as illustrative rather than restrictive. Moreover, modifications, variations and changes may be made by those skilled in the art without departure from the spirit and scope of the invention as described by the following claims.

What is claimed is:

1. A signaling package for being disposed within a container of goods, comprising:
a vessel having side walls that define a cavity;
a piercing tip projecting from a first end of the vessel; and
a signaling device secured within the cavity,
whereby the piercing tip, bearing against a container, pierces an opening in the container for sliding passage of the vessel into the container.

2. The signaling package as recited in claim 1, wherein the cavity includes an adhesive for securing the signaling device therein.

3. The signaling package as recited in claim 1, further comprising a flange extending outwardly from a wall defining a second end of the vessel, whereby a tool engages the flange and the wall to facilitate pushing the vessel into the container.

4. The signaling package as recited in claim 3, wherein the flange is substantially centrally disposed relative to the edges of the wall defining the second end of the vessel.

5. The signaling package as recited in claim 1, wherein the piercing tip defines a tapering edge extending at an oblique angle from a bottom surface to a point at an outwardly distal end.

6. The signaling package as recited in claim 1, wherein the piercing tip defines a substantially narrow semi-pyramidal projection from the vessel.

7. The signaling package as recited in claim 1, wherein the signaling device is secured within the cavity by closing the recessed cavity with a filler material.

8. The signaling package as recited in claim 1, wherein the signaling device includes an adhesive layer for engaging a bottom surface of the recessed cavity.

9. The signaling package as recited in claim 8, wherein the signaling device includes a removable sheet covering the adhesive layer, which sheet is detached prior to securing the signaling device within the recessed cavity.

10. The signaling package as recited in claim 1, wherein the signaling device is an electronic article surveillance tag.

11. The signaling package as recited in claim 1, wherein the signaling device is a radio frequency identification device.

12. The signaling package as recited in claim 1, wherein the signaling device is a mechanical device that responses to a signal.

13. A method of providing containers with a signaling package, comprising the steps of:
(a) securing a signaling device within a cavity of a vessel having a piercing tip projecting from a first end;
(b) opening a hole in a container by pushing the piecing tip into the container; and
(c) sliding the remaining portion of the vessel through the hole into the container.

14. The method as recited in claim 13, further comprising the step of providing an adhesive material for securing the signaling device within the recessed cavity.

15. The method as recited in claim 13, wherein the step (b) opening comprises the steps of engaging a flange extending outwardly from a wall defining a second end of the vessel in a tool and operating the tool to push against the second end of the vessel.

16. In combination:
one of a container of goods;
a signaling package inserted in said container, the signaling package comprising:
a vessel defining a cavity;
a piercing tip projecting from an end of the vessel; and
a signaling device secured within the cavity,
whereby the piercing tip, bearing against the container, pierces an opening in the container for sliding passage of the vessel into the container.

17. The signaling package as recited in claim 1, wherein the signaling device is an electronic article surveillance tag.

18. The signaling package as recited in claim 1, wherein the signaling device is a radio frequency identification device.

19. The signaling package as recited in claim 1, wherein the signaling device is a mechanical device that responses to a signal.
